(19) United States
(12) Patent Application Publication
(10) Pub. No.: US 2007/0008465 A1
(43) Pub. Date: Jan. 11, 2007

(54) Flexible reflective display device and manufacturing method for the same

(76) Inventors: Jau-Min Ding, Taipei City (TW); Chi-Chang Liao, Tai Nan City (TW); Yi-An Sha, Taipei City (TW); Hsing-Lung Wang, Ping Jen City (TW)

Correspondence Address: RABIN & BERDO, P.C., Suite 500, 1101 14 Street, N.W., Washington, DC, 20005, US

(21) Appl. No.: 11/257,057

(22) Filed: Oct. 25, 2005

(30) Foreign Application Priority Data
Jul. 8, 2005 (TW) 94123242

(51) Int. Cl. G02F 1/1335

(52) U.S. Cl. 349/113

(57) ABSTRACT

A flexible reflective display device and a manufacturing method for the same are disclosed. The present invention is formed by introducing flexible printed circuit board manufacture technology together with flexible display technology. The flexible reflective display device, comprising an upper substrate, a display medium layer formed on the upper substrate, and a lower flexible printed circuit substrate; a first electrode layer formed on the upper substrate in the interface between the upper substrate and the display medium layer; a second electrode layer formed on the flexible printed circuit substrate; and an adhesive layer formed between the display medium layer and the flexible printed circuit substrate.

### BACKGROUND OF THE INVENTION

1. Field of the Invention

This invention relates to a display device and manufacturing method for the same, and more particularly to a flexible reflective display device and a manufacturing method for the same.

2. Description of Related Art

A display device is designed to be light, thin, portable and compatible with many different electronic products. The substrate of display panels for electrical products was previously made of conventional glass substrate. Today however, they are increasingly being produced using a flexible substrate.

Currently, flexible substrate technology is restrained by the materials that are used to make display devices. Certain key problems plague the technology and demand a solution. For example, the stability of the heating process, the restrictions upon varying the shape of the substrate, the suitability and applicability of certain surface materials and the need for a waterproof surface, are just some of the problems that need to be solved in the near future.

Several manufacturing methods for flexible substrate or related art are disclosed in the following prior patent documents. For example, U.S. Pat. App. No. 2002/0180344, entitled “Flexible Electronic Device”, discloses a flexible electronic device having a flexible display panel. In FIG. 1, a schematic view of the device according to the prior art is illustrated. The flexible electronic device comprises a flexible display panel 10, a flexible circuit substrate 12 and a source 14.

### SUMMARY OF THE INVENTION

Flexible printed circuit boards are a well-developed technology. The present invention offers a suitable structural design and an excellent flexible display manufacturing process.

To achieve the above object, the present invention proposes a method of manufacturing a flexible reflective display device, which comprises the steps of: providing an upper substrate and a lower substrate; forming a first electrode on the upper substrate; forming a second electrode on the lower substrate; forming a display medium layer between the upper substrate and lower substrate; and forming a adhesive layer between the display medium layer and the lower substrate.

The present invention also provides a flexible display device and an electrode layout for a reflective flexible display device and its related embodiments.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view illustrating a flexible electronic device of the prior art;

FIG. 2 is a schematic view illustrating the flexible reflective display device of the present invention;

FIG. 3 is a schematic view illustrating a first embodiment of an electrode layout of the present invention;

FIG. 4 is a schematic view illustrating a second embodiment of an electrode layout of the present invention;

FIG. 5 is a schematic view illustrating a first embodiment of a display medium layer of the present invention; and

FIG. 6 is a schematic view illustrating a second embodiment of a display medium layer of the present invention.

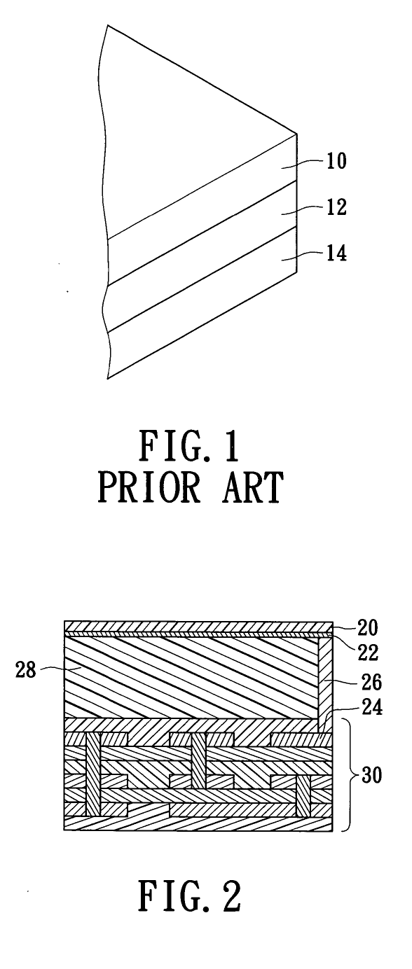

### DETAILED DESCRIPTION OF THE PREFERRED EMBODIMENTS

FIG. 2 is a schematic view illustrating a flexible reflective display device of the present invention. The flexible reflective display device comprises an upper substrate 20, wherein the upper substrate 20 is made of a transparent material. A first electrode layer 22 is formed on the upper substrate 20, wherein the first electrode layer 22 is made of a transparent conductive material. A second electrode layer 24 is formed on a lower substrate 30, wherein the second electrode layer 24 is designed as a multi-layer structure electrode and complex electrode patterns may be arranged thereon. The lower substrate 30 is a flexible printed circuit board. The flexible printed circuit board can be single layered, double layered or multi-layered. The flexible printed circuit board is connected to a drive circuit board using a design that utilizes a slot structure, or is disposed upon a chip on the flexible printed circuit board using chip on flexible printing circuit board technology. This integrates the drive circuit board with the display panel so that they form a single structure. A conductive material layer 26 is disposed between the first electrode layer 22 and the second electrode layer 24.

A display medium layer 28 is formed between the upper substrate 20 and the lower substrate 30. An electrode surface of the lower substrate 30 abuts the display medium layer 28 via a surface modification process that forms a light reflecting/absorbing surface. Furthermore, the display medium layer 28 is disposed upon a microstructure 280 (not shown in FIG. 2) to maintain a space between the first electrode 22 and the lower substrate 30 and limit the display medium flow range within the microstructure 280. The microstructure 280 is formed via a Microcup or a capsule process, as shown in FIG. 5 and FIG. 6.

FIG. 5 is a schematic view illustrating the microstructure formed using the Microcup process. FIG. 6 is a schematic view illustrating the microstructure formed via the capsule process. The types of the microstructure 280 include a closed structure or an open structure. The closed structure type of the microstructure 280 has a tetragon trellis structure, a hexagon trellis structure or an irregular porous structure. The open structure type of the microstructure 280 has a columnar structure, a crossed structure or an irregular structure.

A plurality of display mediums of the display medium layer 28 may be formed using liquid crystal, a propelled mixture principally formed of liquid crystal, or electrophoresis. The display medium layer 28 is arranged with an alignment layer, a polarizing film or various compensation films made of various modes of flexible reflective displays when the display medium uses liquid crystal or the propelled mixture principally formed of liquid crystal and uses a microcup structure. The bottom of the display medium (having a microcup structure or a capsule structure) abuts an absorbent light layer or a dyed layer to reduce glare when the display medium uses a reflective-type display medium (such as cholesteric liquid crystal) or a scatter-type display medium (such as polymer dispersed liquid crystal). An adhesive layer 32 is formed between the display medium layer 28 and the lower substrate 30. The adhesive layer 32 is made of a transparent, a dyed or an absorbent material and formed using a film-type layer via a press molding process or formed using a fluid-type layer via a coating process.

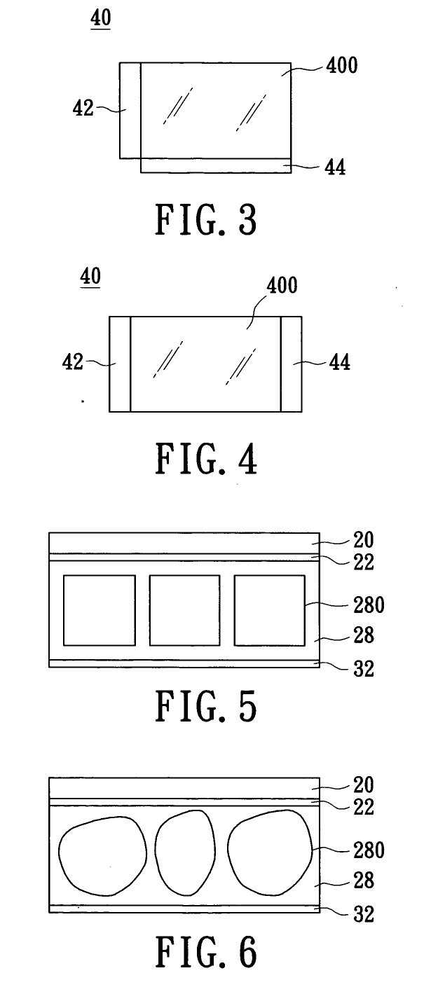

FIG. 3 is a schematic view illustrating a first embodiment of an electrode layout of the present invention. The first embodiment of the electrode layout comprises a flexible reflective display device, wherein the flexible reflective display device comprises a display area 400, an upper substrate and a lower substrate. The upper substrate is made of the transparent material and the electrode of the upper substrate display area and the electrodes of the lower substrate display area are orthogonal shaped parallel electrodes. The lower electrode layer is designed as a multi-layer structure electrode. A top electrode of the lower substrate and a bottom electrode of the lower substrate are disposed between an insulation layer. This has a flattening effect on the layout of the lower electrodes. However, this does not affect the rough surface of the upper electrodes. The connection pin of the lower electrode layout is disposed to right side of the display panel using the layout pattern design of the lower electrode is shown in FIG. 4.

A first bonding area 42 is disposed on the upper substrate, wherein the inside of the first bonding area has a conductive wire that transmits a drive signal to the electrode of a display area. A second bonding area 44 is disposed on the lower substrate, wherein the inside of the second bonding area has a conductive wire that transmits a drive signal to the electrode of the display area. The first bonding area 42 and the second bonding area 44 may be bonded on any side of the display area, either separately on different sides or together on the same side, as is shown in FIG. 3 and FIG. 4. The first bonding area 42 and the second bonding area 44 are bonded on the neighbor side of the display area as shown in FIG. 3. The display panel does not have the flexible characteristic of the first embodiment. When the first bonding area 42 and the second bonding area 44 are bonded on the same side of the display area or on opposite sides of the display area (as shown in FIG. 4), the display device of the present invention is flexible. However, when the first bonding area 42 and the second bonding area 44 are bonded on the display area at a ninety-degree angle to each other (as shown in FIG. 3) the display device of the present invention is not flexible.

FIG. 4 is a schematic view illustrating a second embodiment of the electrode layout of the present invention.

The flexible reflective display device of the present invention is formed using flexible printed circuit board manufacturing technology and flexible display technology for ease of manufacture and decreased production costs. Flexible printed circuit board manufacturing technology, is a common and well-known technology, therefore the product design is extremely flexible and sufficiently displays the advantage of a flexible display.

This concludes the description of the preferred embodiments. Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts, arrangements and/or uses of the subject combination arrangement within the scope of the foregoing disclosure, the drawings and the appended claims without departing from the spirit of the invention.

What is claimed is:

1. A method for manufacturing a flexible reflective display device, comprising steps of:
providing an upper substrate and a lower substrate;
forming a first electrode on the upper substrate;
forming a second electrode on the lower substrate;
forming a display medium layer on the upper substrate; and
forming an adhesive layer between the display medium layer and the lower substrate.

2. The method according to claim 1, wherein the upper substrate is made of a transparent material.

3. The method according to claim 1, wherein the first electrode is made of a transparent conductive material.

4. The method according to claim 1, wherein the lower substrate is a flexible printed circuit board.

5. The method according to claim 1, wherein the second electrode is designed as a multi-layered structure electrode.

6. The method according to claim 1, further comprising a conductive material layer disposed between the first electrode and the second electrode.

7. The method according to claim 4, wherein an electrode surface of the lower substrate abuts the display medium layer via a surface modification processing manner forming a surface of that reflects light, partly reflects light, or absorbs light.

8. The method according to claim 1, further comprising a microstructure on the display medium layer that maintains the distance between the first electrode and the lower substrate and limits the display medium flow range within the microstructure.

9. The method according to claim 8, wherein the microstructure is formed via a microcup or an encapsulation process.

10. The method according to claim 8, wherein the shape of the microstructure is a close shape or an open shape.

11. The method according to claim 10, wherein the close shape structure has a tetragon trellis structure, a hexagon trellis structure or an irregular porous structure.

12. The method according to claim 10, wherein the open shape structure has a columnar structure, a crossed structure or irregular structure.

13. The method according to claim 1, wherein a plurality of display mediums of the display medium layer are formed of liquid crystal, a mixture principally formed of liquid crystal, or electrophoretic display medium.

14. The method according to claim 13, wherein the display medium layer is arranged with an alignment layer, a polarizing film or various compensation films to make various modes of flexible reflective display when the display medium uses liquid crystal or the mixture principally formed of liquid crystal together with the microcup display medium structure.

15. The method according to claim 1, wherein the adhesive layer is made of transparent, dyed or absorbent material.

16. The method according to claim 1, wherein the adhesive layer is a film type or a fluid type material.

17. The method according to claim 16, wherein the film type adhesive layer is formed via a dry film lamination process.

18. The method according to claim 16, wherein the fluid type of adhesive layer is formed via a coating process.

19. A flexible reflective display device, comprising:
an upper substrate and a lower substrate;
a first electrode layer formed on the upper substrate;
a second electrode layer formed on the lower substrate;
a display medium layer formed on the surface of the first electrode layer; and
an adhesive layer formed between the display medium layer and the second electrode surface.

20. The method according to claim 19, wherein the upper substrate is made of a transparent material.

21. The method according to claim 19, wherein the first electrode layer is made of a transparent material.

22. The method according to claim 19, wherein the lower substrate is a flexible printed circuit board.

23. The method according to claim 22, wherein the flexible printed circuit board can be connected to a driving circuit board by a slot structure.

24. The method according to claim 22, wherein a driving circuit can be designed on the flexible printed circuit board directly.

25. The method according to claim 19, wherein the second electrode is designed as a multi-layered structure electrode.

26. The method according to claim 19, further comprising a conductive material layer disposed between the first electrode layer and the second electrode layer.

27. An electrode layout for a flexible reflective display device, comprising:
a flexible reflective display device, wherein the flexible reflective display device comprises a display area, an upper substrate and a lower substrate;
a first bonding area disposed on the upper substrate, wherein the inside of the first bonding area has conductive wires that transmits drive signals to the electrodes of the display area; and
a second bonding area disposed on the lower substrate, wherein the inside of the second bonding area has conductive wires that transmits drive signals to the electrodes of the display area.

28. The device of claim 27, wherein the upper substrate is made of a transparent material.

29. The device of claim 27, wherein the lower substrate is a flexible printed circuit board.

30. The device of claim 27, wherein the electrode of the upper substrate display area and the electrode of the lower substrate display area are orthogonal shaped parallel electrodes.

31. The device of claim 27, wherein the first bonding area and the second bonding area are bonded on the display area at a ninety-degree angle to each other.

32. The device of claim 27, wherein the first bonding area and the second bonding area are bonded on the opposite side of the display area.

33. The device of claim 27, wherein the first bonding area and the second bonding area are bonded on the same side of the display area.

34. The device of claim 27, wherein the electrode of lower substrate is designed as a multi-layered structure electrode.
